(19) United States
(12) Patent Application Publication
(10) Pub. No.: US 2006/0089812 A1
(43) Pub. Date: Apr. 27, 2006

(54) System and method for evaluating clustering in case control data

(76) Inventor: Geoffrey M. Jacquez, Ypsilanti, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/224,158

(22) Filed: Sep. 12, 2005

Related U.S. Application Data
(60) Provisional application No. 60/621,905, filed on Oct. 25, 2004.

(51) Int. Cl. G01N 31/00; G06F 19/00

(52) U.S. Cl. 702/23

(57) ABSTRACT

A method and system to evaluate clustering in case control data for a plurality of individuals taking into account dynamic location information. A set of space time coordinates for each individual is established. The set of space time coordinates indicate a geographic location of a residence of the individual at a beginning time and an ending time. A case control identifier for each individual is established. For at least one case individual whose case control identifier has the first value, a spatially and temporally local case-control cluster statistic is established as a function of the set of space time coordinates of each individual, the case control identifier, and the neighbor relationship values between the one case individual and the other individuals. Dynamic location information for exposure sources are used to establish a focused case-control cluster statistic as a function of the set of space time coordinates of each exposure source, the space time coordinates of each individual, the case control identifier, and the neighbor relationship values between the case individuals, the other individuals and the exposure sources.

### RELATED APPLICATIONS

The present application claims the benefit of U.S. Provisional Patent Application Ser. No. 60/621,905 filed on Oct. 25, 2004, and is incorporated herein by reference.

### FIELD OF THE INVENTION

The present invention relates generally to the evaluation of case control data, and more particularly, to a system and method for identifying geographic, temporal and space-time clustering in multi-dimensional data using location histories.

### BACKGROUND OF THE INVENTION

U.S. population-based surveys estimate that adults spend 87% of their day indoors, 69% in their place of residence, and 6% in a vehicle. To date, almost all published disease cluster investigations use static geographies in which individuals are assumed to be sessile, e.g., geocoded place of residence at time of diagnosis or death is used to record the locations of health events, even though most researchers acknowledge that residential mobility should be accounted for, especially for diseases with long latencies such as cancer. In a recent review of standard methods for relating exposure/hazards, disease mapping and clustering techniques, Bayesian approaches, Markov Chain Monte Carlo (MCMC) and geostatistical methods, Mather et al identify (1) the lack of temporal referencing of geospatial data and (2) the inability of disease clustering methods to account for residential histories as substantial weaknesses (See, Mather, F J, L E Whited, E. C Langlois, C F Shorter, C M. Swalm, J G. Shaffer and W R Harley. 2004. Statistical methods for linking health, exposure and hazards. Environmental Health Perspectives 112:1440-1445). The representation of individuals as sessile (immobile) rather than vagile (mobile) in part is due to the static world view of GIS software (See Goodchild, M. (2000). GIS and Transportation: Status and Challenges. GeoInformatica 4: 127-139), which is largely incapable of representing both human mobility and temporal change. Recently, technological advances have resulted in Space Time Intelligence Systems that implement several constructs from Geographic Information Science for representing human mobility (see Jacquez G M, Greiling D, Kaufmann A. 2005. Design and implementation of a Space-Time Intelligence System for disease surveillance. Journal of Geographical Systems 2005, 7:7-23.

Cluster tests work within a hypothesis testing framework that proceeds by calculating a statistic (e.g. clustering metric) to quantify a relevant aspect of spatial pattern in a health outcome (e.g. case/control location, disease incidence, or mortality rate). The numerical value of this statistic is then compared to the distribution of that statistic's value under a null spatial model, providing a probabilistic assessment of how unlikely an observed cluster statistic is under the null hypothesis (See, Gustafson, E. J. 1998. “Quantifying landscape spatial pattern: What is the state of the art?” Ecosystems(1): 143-156. Waller and Jacquez formalized this approach by identifying five components of a spatial cluster test (Waller, L. A. and G. M. Jacquez. 1995. “Disease models implicit in statistical tests of disease clustering.” Epidemiology 6(6): 584-590). The test statistic quantifies a relevant aspect of spatial pattern (e.g. Moran's I, Moran P A. 1950. Notes on continuous stochastic phenomena. Biometrika 1950, 37:17-23.). The alternative hypothesis describes the spatial pattern that the test is designed to detect. This may be a specific alternative, such as a circular cluster for the scan statistic, or it may be the omnibus “not the null hypothesis”. The null hypothesis describes the spatial pattern expected when the alternative hypothesis is false (e.g. uniform cancer risk). The null spatial model is a mechanism for generating the reference distribution. This may be based on distribution theory, or it may use randomization (e.g. Monte Carlo) techniques. Many disease cluster tests employ heterogeneous Poisson and Bernoulli models for specifying null hypotheses. The reference distribution is the distribution of the test statistic when the null hypothesis is true. Comparison of the test statistic to the reference distribution allows calculation of the probability of observing that value of the test statistic under the null hypothesis of no clustering. This five-component mechanism underpins most commonly used clustering methods.

There are dozens of cluster statistics that may be categorized for convenience as global, local, and focused tests. Global cluster statistics are sensitive to spatial clustering, or departures from the null hypothesis, that occur anywhere in the study area. Many early tests for spatial pattern are global tests and provide one statistic that summarizes spatial pattern over the entire study area. While global statistics can determine whether spatial structure (e.g. clustering, autocorrelation, uniformity) exists, they do not identify where the clusters are, nor do they quantify how spatial dependency varies from one place to another.

Local statistics such as Local Indicators of Spatial Autocorrelation LISA (See, Ord J. K. and Getis A. 1995. Local spatial autocorrelation Statistics: Distributional issues and an application. Geographical Analysis 27:286-306) quantify spatial autocorrelation and clustering within the small areas that together comprise the study geography. Local statistics quantify spatial dependency (e.g. not significantly different from the null expectation, cluster of high values, cluster of low values, and high or low spatial outlier) in a given locality. Many local statistics have global counterparts that often are calculated as functions of local statistics. For example, Moran's I is the sum of the scaled local Moran statistics.

Focused statistics quantify clustering around a specific location or focus. These tests are particularly useful for exploring possible clusters of disease near potential sources of environmental pollutants. For example, Lawson (Lawson, A. B. 1989. “Score tests for detection of spatial trend in morbidity data.” Dundee: Dundee Institute of Technology) and Waller et al. (Waller, L. A., B. W. Turnbull, L. C. Clark, and P. Nasca. 1992. Chronic disease surveillance and testing of clustering of disease and exposure: Application to leukemia incidence and TCE-contaminated dumpsites in upstate New York. Environmetrics 3: 281-300) proposed tests that score each area for the difference between observed and expected disease counts, weighted by exposure to the focus (also see Lawson A B, Waller L A. 1996. A review of point pattern methods for spatial modelling of events around sources of pollution. Environmetrics 7:471-487 for a review of these approaches). A commonly used exposure function is inverse distance to the focus (1/d). The null hypothesis is no clustering relative to the focus, with expected number of cases calculated as the Poisson expectation using the population at risk in each area and the assumption that risk is uniform over the study area.

Hundreds of cluster investigations are recorded in the literature, and several of these have resulted in cancer control activities such as epidemiological studies to understand potential causes. But to date, none of these studies account for human mobility.

Hagerstrand (Hagerstrand, T, 1970. What about people in regional science? Papers of the Regional Science Association, 24: 7-21) conceptualized the space time path as an individual's continuous physical movement through space and time, and visually represented this as a 3-dimensional graph. Hornsby and Egenhofer (Hornsby, K and M. Egenhofer 2002. Modeling moving objects over multiple granularities, Special issue on Spatial and Temporal Granularity, Annals of Mathematics and Artificial Intelligence. 36: 177-194) recognized that space-time paths mediate individual-level exposure to pathogens and environmental toxins, and that practical application would require a mechanism for representing location uncertainty. A space time prism refers to the possible locations an individual could feasibly pass through in a specific time interval, given knowledge of their actual locations in the times bracketing that interval. The potential path area (see, Miller, H. 2005. A measurement theory for time geography. Geographical Analysis 37:17-45) shows the locations the individual could occupy given these constraints, and represents places where exposure events might occur. These constructs enabled new research approaches in diverse fields such as student life, sports analysis, social systems, transportation, and the analysis of disparities in gender accessibility in households. While these approaches provide a proven mechanism for modeling geospatial lifelines and related constructs, the prior art lacks an effective method for the statistical evaluation of clustering among such lifelines.

The present invention is aimed at one or more of the problems identified above.

### SUMMARY OF THE INVENTION

In a first aspect of the present invention, a method of evaluating clustering in case control data for a plurality of individuals taking into account dynamic location information is provided. The method includes the steps of establishing a set of space time coordinates for each individual, establishing a case control identifier for each individual, and establishing a neighbor relationship value between each individual and the other individuals. The method further includes the step of, for at least one case individual whose case control identifier has the first value, establishing a spatially and temporally local case-control cluster statistic as a function of the set of space time coordinates of each individual, the case control identifier, and the neighbor relationship values between the one case individual and the other individuals.

In a second aspect of the present invention, a method of evaluating clustering in case control data for a plurality of individuals taking into account dynamic location information is provided. The method includes the steps of establishing a set of space time coordinates for each individual, establishing a case control identifier for each individual, establishing a neighbor relationship value between each individual and the other individuals, and, for at least one case individual whose case control identifier has the first value, establishing a spatially and temporally local case-control cluster statistic as a function of the set of space time coordinates of each individual, the case control identifier, and the neighbor relationship values between the one case individual and the other individuals. The method further includes steps of establishing a probability of another individual being a case, establishing a global statistic for spatial clustering of cases at a time, t, as a function of the case control identifiers and a neutral model of spatially heterogeneous population density, establishing a sum of the global statistic for spatial clustering over times, T+1, and establishing first test statistic as a function of the global statistic for spatial clustering, the first test statistic being indicative of whether cases tend to cluster through time around a specific case. The method also includes the steps of identifying a focus individual, where cases may be clustering about the focus individual, establishing a lifeline for the focus individual, establishing a second test statistic representing a count of neighbors of the focus individual who are cases at a focus time, and establishing a third test statistic as a function of the second test statistic. The third test statistic representing count of neighbors of the focus individual who are cases between the beginning time and the ending time.

In a third aspect of the present invention, a system of evaluating clustering in case control data for a plurality of individuals taking into account dynamic location information is provided. The system includes a database for storing case control data and a computer. The computer establishes a set of space time coordinates for each individual, establishes a case control identifier for each individual, and establishes a neighbor relationship value between each individual and the other individuals. The computer further, for at least one case individual whose case control identifier has the first value, establishes a spatially and temporally local case-control cluster statistic as a function of the set of space time coordinates of each individual, the case control identifier, and the neighbor relationship values between the one case individual and the other individuals.

In a fourth aspect of the present invention, a system of evaluating clustering in case control data for a plurality of individuals taking into account dynamic location information is provided. The system includes a database for storing case control data and a computer. The computer of establishes a set of space time coordinates for each individual, establishes a case control identifier for each individual, establishes a neighbor relationship value between each individual and the other individuals, and, for at least one case individual whose case control identifier has the first value, establishes a spatially and temporally local case-control cluster statistic as a function of the set of space time coordinates of each individual, the case control identifier, and the neighbor relationship values between the one case individual and the other individuals. The computer further establishes a probability of another individual being a case, establishes a global statistic for spatial clustering of cases at a time, t, as a function of the case control identifiers and a neutral model of spatially heterogeneous population density, establishes a sum of the global statistic for spatial clustering over times, T+1, and establishes first test statistic as a function of the global statistic for spatial clustering. The first test statistic establishes is indicative of whether cases tend to cluster through time around a specific case. The computer also identifies a focus individual, establishes a second test statistic representing a count of neighbors of the focus individual who are cases at a focus time, and establishes a third test statistic as a function of the second test statistic. The third test statistic representing count of neighbors of the focus individual who are cases between the beginning time and the ending time.

In a fifth aspect of the present invention, a system of evaluating those exposure sources that might give rise to a given case of cancer taking into account known exposure sources, knowledge of the carcinogenicity and amounts of putative carcinogens emitted by those sources, and dynamic location information is provided. The system includes a database for storing location information for the case, databases for storing the locations of exposure sources, the emissions from those sources, and the carcinogenicity of the emitted compounds, and a computer. The computer establishes a set of space time coordinates for the case, and for the exposure sources. The computer further establishes a history of the emissions from exposures sources in the vicinity of the locations recorded for the case, the amounts of emission for each compound that is a known or suspected carcinogen for the cancer under consideration, and from this creates a list of the possible carcinogens that could have given rise to the observed cancer case. This list documents the carcinogens that might have given rise to the observed cancer, the amount of emissions from exposure sources near the locations recorded in that case's location history, the relative importance of these emitted carcinogens in terms of their carcinogenicity and amount emitted, and the locations of the exposure sources that emitted these carcinogens.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a simplified diagram of a system for evaluating clustering in control data, according to an embodiment of the present invention;

FIG. 2 is a simplified flow diagram of a method for evaluating clustering in control data, according to an embodiment of the present invention;

FIG. 3 is a three-dimensional graphical representation of residential histories;

FIG. 4 is a graph of a test statistic and its probability for sample control data, according to an embodiment of the present invention;

FIG. 5 is a graph of another test statistic and its probability for sample control data, according to an embodiment of the present invention;

FIG. 6 is a scatter-graph of the probability associated with a test statistic using sample control data;

FIG. 7 is a map of cases and controls for sample control data;

FIG. 8 is a scatter-graph of the probability associated with a second test statistic using sample control data; and,

FIG. 9 is a scatter-graph of the probability associated with a third test statistic using sample control data.

### DETAILED DESCRIPTION OF INVENTION

With reference to the drawings and in operation, the present invention provides a system 10 and a method 30 for evaluating clustering in case control data for a plurality of individuals taking into account dynamic location information. The present invention may be used to analyze health related data, e.g., to cases of specific cancers, for a plurality of mobile individuals. The present invention provides local and/or focused and/or global tests for residential histories based on nearest neighbor relationships that reflect the changing topology of cases (incidences) and control individuals. It should be noted that for the purposes of the present invention an individual's dynamic location or residence refers to the individual location within a known or defined environment and may include, e.g., the individual's residence within a state, country, or worldwide, or may include an individual's location within a building, e.g., an apartment, residence hall, or office building.

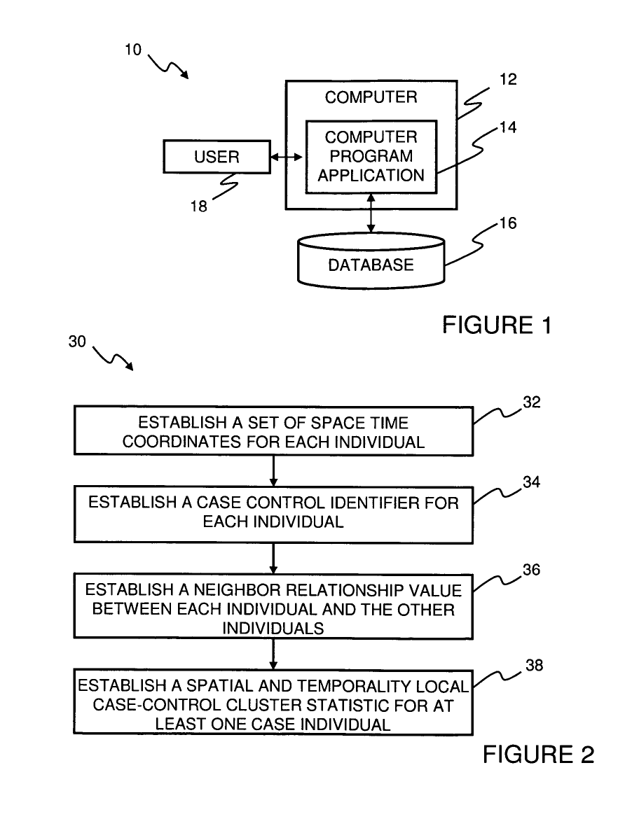

With specific reference to FIG. 1, in one embodiment, the system 10 includes a computer 12, such as a personal computer or workstation. The computer 12 may be a stand-alone computer or connected to other computers in a network (not shown). The present invention may be embodied in a computer program application 14 run on the computer 12. A database 16 is coupled to the computer 12 and is used to store case control data and location history data. In addition and in one embodiment, a database describing the locations and times of operation of putative sources of carcinogens is provided, along with data describing the specific carcinogens emitted and their amounts, which may vary through time. In one embodiment, the database 16 is located on and maintained via the computer 12. However, the database 16 may also be located on another computer (not shown) connected to, and accessible by, the computer 12. A user or user 18 may interact with the computer program application 14 via the computer 12 in a conventional manner. It should also be noted that the term database is used to refer to a computer file or files which may be used to store and maintain the required data, including but not limited to, ASCII files, text files, files accessible by a word-processing or editing computer program, files accessible by a database computer program, or files accessible by a spreadsheet computer program.

As discussed, in one embodiment the present invention may be embodied in the program application 14 which is “run” by the user or users 18. Operation of the system 10 and the computer program application 14 will now be discussed in an exemplary embodiment below.

With particular reference to FIG. 2, in a first step 32, the method 30 establishes neighbor relationship value between each individual and the other individuals. In one embodiment, the neighbor relationship value between one individual and another individual has a first relationship value if the one individual and the another individual are neighbors according to a set of predetermined criteria and a second relationship value if they are not neighbors (see below).

In a second step 34, a case control identifier for each individual is established. In one embodiment, the case control identifier has a first control value if the individual is a case and a second control value if the individual is not a case (see below).

In a third step 36, a neighbor relationship value between each individual and the other individuals is established. In one embodiment, the neighbor relationship value between one individual and another individual has a first relationship value, if the one individual and the another individual are neighbors according a set of predetermined criteria and a second relationship value are not neighbors (see below).

In a fourth step 38, for at least one case individual whose case control identifier has the first value, a spatially and temporally local case-control cluster statistic is established as a function of the set of space time coordinates of each individual, the case control identifier, and the neighbor relationship values between the one case individual and the other individuals. An exemplary embodiment of the system 10 and method 30 will now be discussed with references to specific examples and equations. However, it should be noted that these are for illustration purposes only and the present invention is not related to such.

Cluster Methods for Residential Histories

Notation

The coordinate u_{i,t}={x_{i,t}, y_{i,t}} is defined to indicate the geographic location of the place of residence of the i^{th} case or control at time t. Residential histories for individual cases and controls can then be represented as the set of space-time locations as:
Lᵢ=(uᵢ₀, uᵢ₁, . . . , u_{iT}) (Equation 1).

Equation 1 defines individual i living at his or her place of residence found at uᵢ₀ at the beginning of the study (time 0 or the beginning time), and moving to location uᵢ₁ at time t=1. At the end of the study (or the ending time) individual i may be found at u_{iT}. T is defined to be the number of unique observation times on all individuals in the study. This bears some emphasis as understanding of how T is recorded is essential in order to understand the cluster tests for residential histories. T is the total number of different observation times across all individuals, and so one might expect several locations in an individual residential history to be the same. For example, suppose we have 2 individuals (A and B) and record their residential histories. We record their places of residence at t=0, the beginning of the study. At some time t=1 “A” moves to a different home, and moves again at time t=2. “B” never moves at all and hence has the location of the same initial place of residence recorded at times t=0, 1, and 2. In this example T=2. Notice the duration between t=0 to t=1 may not equal the duration from t=1 to t=2. This will be important later for duration-weighted versions of the statistics (see below).

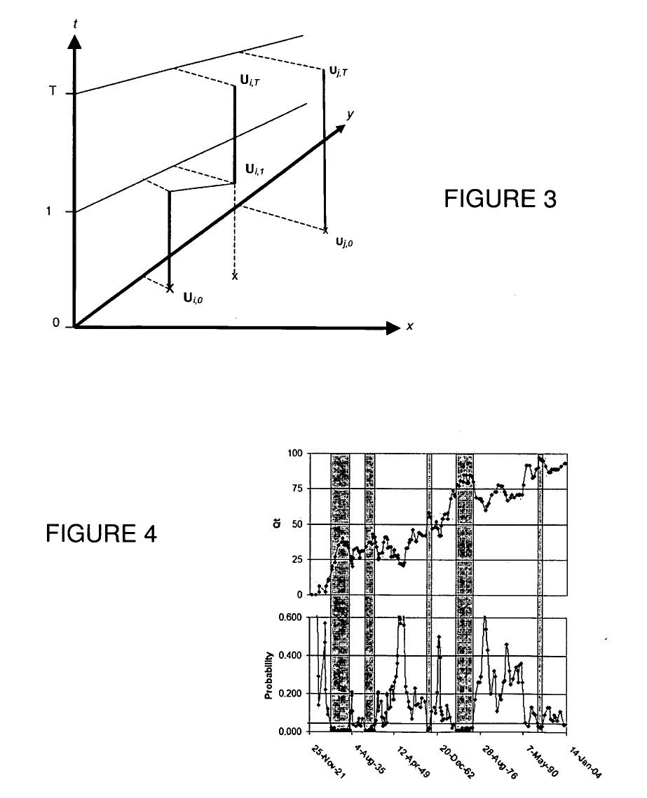

While observations on residential histories occur at a finite number of time points or observation times, these observations do not have to happen at the same time for all individuals under scrutiny. When residential histories are self-reported, these observation times are defined by the “move” dates reported by the respondent. This is modeled as an instantaneous displacement from the spatial coordinates for entity i at time t (uᵢₜ) to those at time t+1 (uᵢₜ₊₁). This instantaneous displacement is defined as occurring at time t+1. We viewed this as an observational model in which the entity is assumed to reside at its known location up until that moment when it is observed elsewhere (see FIG. 3).

Individual residential histories can be associated with time-dependent attributes such as weight, height, disease state, smoking status, case control status, and so on. These attributes may be associated with risk and thereby influence calculation of the latency period and exposure windows defined later. Later we also will use time of diagnosis to define exposure windows during which carcinogenesis was thought to have occurred. For now let us define a case-control identifier, cᵢ to be:

$${c}_{i} = \{ \begin{matrix}1 & if and only if i is a case \\ 0 & otherwise\end{matrix} \qquad ( Equation 2 )$$

Define nₐ to be the number of cases and n_{b} to be the number of controls. The total number of individuals in the study is then N=nₐ+n_{b}.

k-Nearest Neighbor Relationships

Let k indicate the number of nearest neighbors to consider when evaluating nearest neighbor relationships (see for example Jacquez G M. 1996. A k-nearest neighbor test for space-time interaction. Statistics in Medicine 15:1934-1949), and define a nearest neighbor indicator to be:

$${η}_{i , j , k , t} = \{ \begin{matrix}1 & if and only if j is a k nearest neighbor of i at time t \\ 0 & otherwise\end{matrix} . \qquad ( Equation 3 )$$

We then can define a binary matrix of k^{th} nearest neighbor relationships at a given time t as:

$${η}_{k , t} = [ \begin{matrix}0 & {η}_{1 , 2 , k , t} & ⋯ & ⋯ & {η}_{1 , N , k , t} \\ {η}_{2 , 1 , k , t} & 0 & & & ⋮ \\ ⋮ & & ⋮ & & ⋮ \\ ⋮ & & & ⋯ & {η}_{N - 1 , N , k , t} \\ {η}_{N , 1 , k , t} & ⋮ & ⋮ & {η}_{N , N - 1 , k , t} & 0\end{matrix} ] . \qquad ( Equation 4 )$$

By convention we define η_{i,i,k,t}=0 since we do not wish to count individuals as nearest neighbors of themselves. This matrix enumerates the k nearest neighbors (indicated by a 1) for each of the N individuals. The entries of this matrix are 1 (indicating that j is a k nearest neighbor of i at time t) or 0 (indicating j is not a k nearest neighbor of i at time t). It may be asymmetric about the 0 diagonal since nearest neighbor relationships are not necessarily reflexive. Since two individuals cannot occupy the same location, we assume at any time t that any individual has k unique k-nearest neighbors.

While it is true that two individuals cannot occupy the exact same location (e.g. space occupied by one individual's body), residential history information can assign two individuals the same coordinate when they live in the same house. For two individuals with the same address this is not a problem since we would make them 1^{st} order nearest neighbors of one another. It becomes a bit more complicated when 3 or more people occupy the same house, since we are uncertain as to how to assign nearest neighbor relationships. Two approaches have been proposed. The first creates fractional nearest neighbor weights (after Cuzick J, Edwards R. 1990. Spatial clustering for inhomogeneous populations. Journal of the Royal Statistical Society [Ser B] 52:73-104), the second propagates uncertainty in the nearest neighbor relationships by evaluating the permutations of possible nearest neighbors for the tied nearest neighbor relationships (Jacquez G M. 1994. Cuzick and Edwards test when exact locations are unknown. American Journal of Epidemiology 140:58-64). For the bladder cancer data presented later we have a case and a control that co-reside, and treat them as 1^{st} order nearest neighbors of one another.

The row sums thus are equal to k (η_{i,•,k,t,}=k) although the column sums vary depending on the spatial distribution of case control locations at time t. The sum of all the elements in the matrix is Nk. There exists a 1×T+1 vector of times denoting those instants in time when either (1) the system is observed and the locations of the entities are recorded, or (2) under continuous observation at least one entity changes geographic location. We can then consider the sequence of T nearest neighbor matrices defined by
ηₖ^{T}={η_{k,t}; t=0 . . . T} (Equation 5).

This defines the sequence of k nearest neighbor matrices for each unique temporal observation recorded in the data set, and thus quantifies how nearest neighbor relationships change through time. This demonstrates one way in which spatial weights (here the nearest neighbor relationship) can be specified from residential histories. We will now use these nearest neighbor relationships to construct case control spatial cluster tests for residential histories.

Spatially and Temporally Local Spatial Cluster Statistic

A spatially and temporally local case-control cluster statistic is then:

$${Q}_{i , k , t} = {c}_{i} {\sum }_{j = 1}^{N} {η}_{i , j , k , t} {c}_{j} . \qquad ( Equation 6 )$$

This is the count, at time t, of the number of k nearest neighbors of case i that are cases, and not controls (assuming i indeed is a case, if it isn't Q_{i,k,t}=0). Since a given individual i may have k unique nearest neighbors, this statistic is in the range 0 . . . k. It always is 0 when i is a control. When i is a case, low values indicate cluster avoidance (e.g. a case surrounded by controls), and large values (near k) indicate a cluster of cases. When Q_{i,k,t,}=k, all of the k nearest neighbors of case i are cases at time t.

Probabilities, Null Hypotheses and Randomization

The statistical significance of Q_{i,k,t} may be evaluated using conditional randomization that holds the case control identifier for individual i fixed and then allocates the vector of remaining N−1 case-control identifiers across the remaining individuals with a given probability function. If we assume equiprobability such that all individuals have equal disease risk we obtain:

$$P ( {c}_{j} = 1 \vert {c}_{i} , {H}_{IV} ) = \frac{{n}_{a} - {c}_{i}}{{n}_{a} + {n}_{b} - 1} . \qquad ( Equation 7 )$$

Given the case-control identifier for individual i, this is the probability of individual j being a case under Goovaerts and Jacquez's (Goovaerts P, Jacquez G. 2004. Accounting for regional background and population size in the detection of spatial clusters and outliers using geostatistical filtering and spatial neutral models: the case of lung cancer in Long Island, N.Y. International Journal of Health Geographics 3:14) neutral model Type IV (H_{IV}) of spatial independence of risk for a spatially heterogeneous population density. As expressed in Equation 7, the exact number of cases (nₐ) and controls (n_{b}) might not be reproduced under probabilistic sampling.

Their neutral model type V retains a specified level of spatial autocorrelation and may be simulated using rejection sampling, sequential indicator simulation, or conditional case-control index swapping to achieve the observed level of spatial autocorrelation. For imagery, Liebisch et al (Liebisch N, Jacquez G M, Goovaerts P, Kaufmann A. 2002. New methods to generate neutral images for spatial pattern recognition. In Lecture Notes in Computer Science. Volume 2478. Springer-Verlag Berlin Heidelberg; 2002:181-195) referred to this approach as conditional pixel swapping. Probabilities for neutral model type V are difficult to write in a closed form analogous to Equation 7.

Probabilities for neutral model type H_{VI} describe the situation where not all individuals have the same probability of being labeled a case. This occurs, for example, when we are concerned with detecting clusters that arise from additional risk above and beyond that of a background risk (e.g. smoking) and/or covariates (e.g. age) that are themselves spatially heterogeneous. This may be accomplished in a variety of fashions to model known individual and environmental risk factors. Tests of the significance of Q_{i,k,t} are then identifying clusters of cases above and beyond that expected under the neutral model.

One calculates the value of the test statistic for each realization of the spatial distribution of cases generated under the chosen neutral model. These values under randomization are retained and used to construct the reference distribution of the statistic under the corresponding null hypothesis. The observed value of the test statistic for the not randomized data (denoted Qᵢₖₜ*) is then compared to the reference distribution to calculate the probability:

$$P ( {Q}_{ikt}^{*} \vert {H}_{m} ) = \frac{( a + 1 )}{( b + 1 )} . \qquad ( Equation 8 )$$

Here a is the number of conditional randomizations whose cluster statistic was greater than or equal to that observed for the not randomized data, and b is the total number of randomization runs conducted.

A convenient algorithm for conditional randomization under neutral model IV is to hold the case-control identifier for the i^{th} individual constant, and to then draw from the 1×N−1 vector of remaining case-control identifiers new case-control identifiers for the k nearest neighbors surrounding i. This sampling is accomplished without replacement. Alternatively, one could populate the k-nearest neighbors about i using the probabilities from Equation 7. This equation is correct for the first identifier so drawn, but needs to be adjusted for the second, third and so on. For the m^{th} identifier the correct probability for sampling without replacement is:

$$P ( {c}_{m} = 1 \vert {c}_{i} , {c}_{j} ∀ j = 1 … m - 1 , {H}_{IV} ) = \frac{{n}_{a} - {c}_{i} - {\sum }_{j = 1}^{m - 1} {c}_{j}}{{n}_{a} + {n}_{b} - m - 2} . \qquad ( Equation 9 )$$

If one assumes sampling with replacement, so that the cases and controls are assumed drawn from a larger population, one can use Equation 7 without modification.

This approach does not work for neutral models type V and VI, since spatial structure in the background risk is lost. Instead one calculates the value of the test statistic for each of the N locations, for each realization of the spatial neutral model (of type V or VI) that produces a spatial point pattern of cases and controls with the desired level of spatial autocorrelation. The probability assigned to clusters from these tests (as given by Equation 8) then accounts for the specified background variation in disease risk and covariates.

Note for each of the approaches listed above, that a reference distribution, test statistic, and corresponding p-value, may be calculated for each of the nₐ case locations.

Simes Correction for Local Dependency

The k P-values for the k individuals surrounding the i^{th} case are not independent of one another, as they necessarily will include one another as members of their own sets of k nearest neighbors. We therefore employ a modified Simes correction to account for the lack of spatial independence of the Q statistics. Such statistics are not independent because their case-control identifiers enter into calculation of the Q statistics for their neighbors. Their p-values should be adjusted for this lack of independence. We adjust the p-value using the Simes correction (Simes R J. 1986. An improved Bonferroni procedure for multiple tests of significance. Biometrika 1986, 73:751-4), which is not as conservative as the Bonferroni correction. The Simes adjustment is calculated as pᵢ′=(k+1−a) pᵢ. Here k is the number of p-values being considered (the number of neighbors), and a is the index (starting at 1) indicating the location in the sorted vector of the p values for individual i and its neighbors.

Global Test for Spatial Clustering at Time t

A global statistic for spatial clustering at time t may then be constructed as:

$${Q}_{k , t} = {\sum }_{i = 1}^{N} {Q}_{i , k , t} . \qquad ( Equation 10 )$$

This is the space-time form of Cuzick and Edwards (Cuzick J, Edwards R. 1990. Spatial clustering for inhomogeneous populations. Journal of the Royal Statistical Society [SerB] 52:73-104) global test for case-control clustering. It is the count, overall cases, of the number of cases that are k-nearest neighbors to those cases at time t. One could divide this statistic, and others to follow, by nₐ to facilitate the interpretation. For example, the test statistic would then be an average number of neighbor cases per case instead of the integer total number of cases. This also would facilitate comparison across different studies. In this paper we will use the case-count version.

The probability of Q_{k,t} under H_{IV} is evaluated by allocating the case-control id's with equal probability over the N locations at time t. Q_{k,t} is then calculated and this process is repeated b times to construct the reference distribution and probability (Equation 8). Notice that since this is a global test conditional randomization that holds the case-control id for individual i constant is not needed.

Global Test for Spatial Clustering of Residential Histories

A global test for spatial clustering among the N residential histories as represented in Equation 1 is:

$${Q}_{k} = {\sum }_{t = 0}^{T} {Q}_{k , t} . \qquad ( Equation 11 )$$

This is the sum, over all T+1 time points, of the global statistic Q_{k,t}. It is a measure of the persistence of global clustering and is large when case clustering persists through time. Its reference distribution may be constructed under a randomization procedure in which the case-control ids are allocated with equal probability over the residential histories comprising the set:
{Lᵢ, i=1 . . . N} (Equation 12).

Local Test for Spatial Clustering of Residential Histories Through Time

To determine whether cases tend to cluster through time around a specific case we may construct a test statistic:

$${Q}_{i , k} = {\sum }_{t = 0}^{T} {Q}_{i , k , t} . \qquad ( Equation 13 )$$

For the i^{th} residential history, this is the sum, over all T+1 time points, of the local spatial cluster statistic Q_{i,k,t}. It is the number of cases that are k-nearest neighbors of the i^{th} residential history (a case), summed over all T+1 time points. It will be large when cases tend to cluster around the i^{th} case through time. Under neutral model type IV, the significance of Q_{i,k,t} is evaluated under a conditional randomization that holds the case id for i constant, and then allocates the remaining case-control id's at random over the N−1 remaining residential histories. This statistic is useful for determining whether there is local clustering of residential histories about a specific case. The statistic can be calculated for all cases in the data set to identify those cases whose residential histories form local spatial clusters.

Focused Test for Spatial Clustering at Time t

Suppose one suspects the cases may be clustering about a specific focus defined by the lifeline:
L_{F}={u_{F,0}, u_{F,1}, . . . , u_{F,T}} (Equation 14).

This records the locations of the focus as it moves about through space-time, and includes instances in which the focus doesn't move as a degenerate instance as well as instances where the focus is mobile. A test for spatial clustering of cases about the focus at a given time t is then:

$${Q}_{F , k , t} = {\sum }_{j = 1}^{N} {η}_{F , j , k , t} {c}_{j} . \qquad ( Equation 15 )$$

Here η_{F,j,k,t} is the nearest neighbor index indicating at time t whether the j^{th} individual is a k^{th} nearest neighbor of the geographic location of the focus defined by u_{F,t}. The statistic Q_{F,k,t} is then the count of the number of k-nearest neighbors about the focus at time t that are cases. Under null hypothesis type IV randomization at time t may be accomplished by allocating the case control identifiers with equal probability over the N−1 individuals. Since only the k-nearest neighbors are considered it is only necessary to allocate their indices. This may be accomplished by sampling without replacement from the 1×N vector of the case-control identifiers, or by drawing the k required case control identifiers with probabilities defined by Equation 9 (for sampling without replacement) or Equation 7 (for sampling with replacement).

Focused Test for Spatial Clustering of Residential Histories about a Mobile Focus

A test for focused clustering of residential histories through time is:

$${Q}_{F , k} = {\sum }_{t = 0}^{T} {Q}_{F , k , t} . \qquad ( Equation 16 )$$

This is the count, over the T times, of the number of cases that are k nearest neighbors of the focus at each time point. This statistic is large when residential histories that are near the focus are cases. Its maximal value is:
max(Q_{F,k})=kT. (Equation 17).

One drawback of using nearest neighbor relationships for focused tests is that the set of nearest neighbors to the focus are given equal weight in Equations 15 and 16, regardless of their actual geographic distance from the focus. But diffusion and active transport mechanisms that might carry emissions from the focus typically result in higher exposures near the focus, and it thus may make sense to use a maximum distance within which a set of kᵢ nearest neighbors are found. In these instances the set of nearest neighbors to the focus will vary (hence the i subscript denoting the i^{th} focus) depending on the number of cases and controls found within the specified distance of the focus.

Power of the Focused Tests and Specification of the Exposure

Notice that the power of the tests given by Equations 15 and 16 decreases as k approaches N since Q_{F,k,t}=nₐ when k=N, and its probability is then:
P(Q_{F,k,t}|H₀, k=N)=1.0. (Equation 18).

When one wishes to search for clustering in instances where k approaches N power may be retained by constructing a weight function to model the hypothesized exposure. For geographically localized foci this may be based on proximity to the focus. One choice is:

$${w}_{F , j , t} = \frac{1}{{r}_{F , j , t}} . \qquad ( Equation 19 )$$

Here r_{F,j,t} is the rank indicating proximity of the location of the j^{th} individual at time t (as given by u_{j,t}) to the location of the focus at time t(u_{F,t}). For example, the first nearest neighbor to the focus has rank 1, the second rank 2, and so on.

This weight, calculated either based on geographic proximity (as in Equation 19), using geostatistics, or some other means, is then used to construct the weighted focused test at time t of:

$${Q}_{F , k , t}^{′} = {\sum }_{j = 1}^{N} {w}_{F , j , t} {c}_{j} {η}_{F , j , k , t} . \qquad ( Equation 20 )$$

The test for spatial clustering of residential histories about the focus through time is then:

$${Q}_{F , k}^{′} = {\sum }_{t = 0}^{T} {Q}_{F , k , t}^{′} . \qquad ( Equation 21 )$$

Notice these weighted tests are conducted for the k nearest neighbors being considered. When k=N the maximum values are:

$$max ( {Q}_{F , k , t}^{′} ) = {\sum }_{k = 1}^{N} \frac{1}{k} and \\ max ( {Q}_{F , k}^{′} ) = {\sum }_{t = 0}^{T} max ( {Q}_{F , k , t}^{′} ) . \qquad ( Equation 22 )$$

Duration-Weighted Tests for Clustering of Residential Histories

The number of time points defined by the t=0, . . . , T observation times, and the frequency with which they are taken, can have some influence on the value of the above statistics. For example, many repeated observations when there is a chance of clustering could lead to spurious significance for the local and global tests for clustering of residential histories. We therefore develop duration-weighted versions of the tests. Define the duration of the i^{th} time period to be:
ωₜ (Equation 23).

For example, an observed statistic, such as the local case control cluster statistic Q_{i,k,t} has a given value for the period from t to t+1. At time t+1 it takes on the new value defined by Q_{i,kt+1}, and that value pertains until the next observation time t+2. Notice the observation times are separated by periods that are not necessarily of equal duration, so ω₁ does not necessarily equal ωₜ₊₁. One then can define a duration weighted version of the local cluster statistic as:
Q_{i,k,ω}_{ₜ}=Q_{i,k,ω}ₜ (Equation 24).

The units on the duration weighted version are case-time units (e.g. case days). Each of the statistics defined previously can now be redefined as duration weighted versions, with the proviso that all summations through time are from t=0 to t=T−1. Specifically, the duration weighted version of the local statistic is:
Q_{i,k,w}_{ᵢ}=Ση_{i,j,k,t} cᵢ cⱼ ωₜ (Equation 25).

The duration weighted global statistic is:

$${Q}_{k , {w}_{t}} = {\sum }_{i = 1}^{N} {Q}_{i , k , {w}_{t}} . \qquad ( Equation 26 )$$

The duration weighted global statistic for clustering of residential histories is:

$${Q}_{k}^{ω} = {\sum }_{t = 0}^{T - 1} {Q}_{k , {ω}_{t}} . \qquad ( Equation 27 )$$

The duration weighted local statistic for clustering of residential histories is:

$${Q}_{i , k}^{ω} = {\sum }_{t = 0}^{T - 1} {Q}_{i , k , {ω}_{t}} . \qquad ( Equation 28 )$$

The duration weighted focused statistic over period ωₜ is:

$${Q}_{F , k , {ω}_{t}} = {\sum }_{j = 1}^{N} {η}_{F , j , k , t} {c}_{j} {ω}_{t} . \qquad ( Equation 29 )$$

The duration weighted test for focused clustering of residential histories through time is:

$${Q}_{F , k}^{ω} = {\sum }_{t = 0}^{T - 1} {Q}_{F , k , {ω}_{t}} . \qquad ( Equation 30 )$$

The weighted focused test over duration ωₜ is:

$${Q}_{F , k , {ω}_{t}}^{′} = {\sum }_{j = 1}^{N} {w}_{F , j , t} {c}_{j} {η}_{F , j , k , t} {ω}_{t} . \qquad ( Equation 31 )$$

The weighted focused test, duration-based, for residential histories through time is:

$${Q}_{F , k}^{′ {ω}_{t}} = {\sum }_{t = 0}^{T - 1} {Q}_{F , k , {ω}_{t}}^{′} . \qquad ( Equation 32 )$$

When observations are made at regular time points such that ω₀=ω₁= . . . =ω_{T-1} the not time weighted statistics may be used. When observations are recorded at irregular time intervals the duration-based statistics should be used. The not duration-weighted versions also can be used when one wishes to determine whether any of the T+1 configurations of cases and controls are spatially clustered.

Accounting for Exposure Windows and Latency Periods

When dealing with cancers, causative exposures may occur during an exposure window (Δ_{E}), followed by a latency period (Δ_{L}) before cancer is manifested and diagnosed. Given the residential history for case i, Lᵢ, further denote the space-time coordinate representing place of residence at time of diagnosis as u_{i,t}_{_{D}}, noting that u_{i,t}_{_{D}}εLᵢ. We can then define that subset of the residential history Lᵢ over which the exposure window occurred as:
Lᵢ^{E}={u_{i,t}∀ (t_{i,D}−Δ_{L})>t>(t_{i,D}−Δ_{L}−Δ_{E})} (Equation 33).

Here t_{i,D} is the time of diagnosis for individual i. The term (t_{i,D}−Δ_{L}) indicates the time prior to diagnosis when the latency period began and (t_{i,D}−Δ_{L}−Δ_{E}) is the time when the causative exposure began. Hence equation 33 denotes that portion of individual i's residential histories where causative exposures could have occurred. Notice that both the exposure window and latency period could be covariate-adjusted to account for risk factors such smoking and age. In this instance the latency period and exposure window vary from one individual to another and we write:
Lᵢ^{E}={u_{i,t}∀(t_{i,D}−Δ_{i,L})>t>(t_{i,D}−Δ_{i,L}−Δ_{i,E})} (Equation 34).

Here Δ_{i,L} and Δ_{i,E} are the latency period and exposure windows for the i^{th} individual. In either case (Equation 33 or Equation 34) we call Lᵢ^{E} the Exposure trace for the i^{th} individual.

Clustering of Exposure Traces

With the exposure trace defined we now can ask whether places of residence of individuals were spatially clustered while they were exposed, and whether the exposure traces themselves are spatially clustered. To do this we must first define the sampling distributions for the exposure traces, and then apply this sampling protocol to the controls.

Denote the distribution of exposure windows for the cases as Ψ_{E}. Notice this is a distribution of durations. This may be defined empirically as:
\hat{Ψ}_{E}={Δ_{i,E}, i=1, . . . , nₐ} (Equation 35).

Further, define the distribution of times of diagnosis as Ψ_{D}. This may be defined empirically as:
\hat{Ψ}_{D}={t_{i,D}, i=1, . . . , nₐ} (Equation 36).

This is the distribution of points in time defined by the times of diagnosis of the cases. Finally, define the distribution of latency periods as Ψ_{L}. This may be defined empirically as:
\hat{Ψ}_{L}={Δ_{i,L}, i=1, . . . , nₐ}. (Equation 37).

Randomization Procedures for Exposure Traces

In order to evaluate whether exposure traces of the cases cluster we must first construct a randomization procedure for generating representative times of diagnosis, latency periods, and exposure windows. Once this is accomplished we will be able to determine whether the exposure traces for the cases cluster relative to those so constructed for the controls. For a case, the exposure trace is defined by the time of diagnosis and the latency period, with the latency period potentially dependent on age, gender and other covariates. The procedure proceeds as follows:
(1) Since controls are matched to cases, the “time of diagnosis” for each control is set equal to the time of diagnosis for the matched case.

(2) The exposure window and latency period for each control is then defined based on the covariates for each control as was accomplished for that controls matched case.

(3) Completion of steps (1) and (2) will result in exposure traces defined for both cases and controls. Now randomly assign case control identifiers across the residential histories with equiprobability conditioned on the total number of cases and the total number of controls.

(4) Calculate the desired test statistic for clustering of exposure traces.

(5) Repeat steps 3 and 4 a desired number of times to construct the reference distribution of the statistic under randomization.

Test statistics for assessing clustering of exposure traces are presented below.

Local Case-Control Test for the Spatial Clustering of Exposure Traces at Time t

When health events such as cancers are caused by exposure to geographically localized factors we might expect the exposure traces for the cases to cluster relative to the exposure traces that are generated for the controls. The durations of the exposure traces may vary, and we therefore will employ duration-weighted statistics. We would like to know whether exposure traces for the cases exhibit spatial clustering relative to the controls both locally (to identify places where causative exposures occurred) and globally (to ascertain whether the exposure traces for the cases cluster when considered as a group). We also might wish to ask whether exposure traces for the cases exhibit focused clustering.

The exposure trace for case i (Lᵢ^{E}) records those places where that individual lived during that time when exposures occurred that might have caused cancer later in life. Now define an indicator, e_{i,t}, as:

$${e}_{i , t} = \{ \begin{matrix}1 & if and only if time t is within \\ & the exposure trace for individual i \\ 0 & otherwise .\end{matrix} \qquad ( Equation 38 )$$

When e_{i,t} is 1, let us say the exposure trace is “active”. A local case-control test for spatial clustering of exposure traces at time t is then:

$${Q}_{i , k , t}^{E} = {c}_{i} {e}_{i , t} {\sum }_{j = 1}^{N} {η}_{i , j , k , t} {c}_{j} {e}_{j , t} . \qquad ( Equation 39 )$$

This is the count, at time t, of the number of k nearest neighbors of case i's active exposure trace that are cases (and not controls) whose exposure traces also are active. Hence the statistic will be large when exposure traces of a group of cases are active at about the same time and cluster. Its value is 0 when individual i is a control, and also when individual i is a case with an inactive exposure trace. The duration weighted version of this statistic is:

$${Q}_{i , k , {ω}_{t}}^{E} = {ω}_{t} {c}_{i} {e}_{i , t} {\sum }_{j = 1}^{N} {η}_{i , j , k , t} {c}_{j} {e}_{j , t} . \qquad ( Equation 40 )$$

Local Case-Control Test for the Spatial Clustering of Exposure Traces Through Time

We can explore whether active exposure traces of cases tend to cluster spatially through time. A statistic sensitive to this pattern is:

$${Q}_{i , k}^{E} = {\sum }_{t = 0}^{T} {Q}_{i , k , t}^{E} . \qquad ( Equation 41 )$$

Q_{i,k}^{E} will tend to be large when active exposure traces for cases tend to cluster around the active exposure trace of the i^{th} case. It will be 0 when i is a control, and small when a given case i has the traces of many controls as its neighbors. The duration-based version of this statistic is:

$${Q}_{i , k}^{E , ω} = {\sum }_{t = 0}^{T - 1} {Q}_{i , k , {ω}_{t}}^{E} . \qquad ( Equation 42 )$$

This statistic will be expressed in case-time units, indicating the number (for example) of case-days over the entire study period for which cases with active traces were k-nearest neighbors of the active trace of case i.

Global Case-Control Test for the Spatial Clustering of Exposure Traces at Time t

We can ask whether, as a group, active case traces are spatially clustered relative to the active traces of the controls at a given time t. This is accomplished using the statistic:

$${Q}_{k , t}^{E} = {\sum }_{i = 1}^{N} {Q}_{i , k , t}^{E} . \qquad ( Equation 43 )$$

This is simply the sum, over all cases, of the local statistic for clustering of case exposure traces at time t. This statistic will tend to be large when active traces of cases tend to be near one another, and small when the active traces of cases tend to have controls as their k nearest neighbors. The duration-based version is:

$${Q}_{k , {ω}_{t}}^{E} = {\sum }_{i = 1}^{N} {Q}_{i , k , {ω}_{t}}^{E} . \qquad ( Equation 44 )$$

Global Case-Control Test for the Spatial Clustering of Exposure Traces Through Time

A global test for the spatial clustering of the active exposure traces of cases through time is:

$${Q}_{k}^{E} = {\sum }_{t = 0}^{T} {Q}_{k , t}^{E} . \qquad ( Equation 45 )$$

This is the sum, over all time periods, of the global cluster test for the clustering of exposure traces. It will be large when global clustering of active exposure traces tends to persist through time. The duration-based version of this statistic is:

$${Q}_{k}^{E , ω} = {\sum }_{t = 0}^{T - 1} {Q}_{k , {ω}_{t}}^{E} . \qquad ( Equation 46 )$$

Focused Case-Control Test for the Spatial Clustering of Exposure Traces at Time t

We can also ask whether the exposure traces of cases cluster near putative emission sources. Again, these sources may be mobile, and we accomplish this by assigning larger weights for those cases that are near the focus. Recall from Equation 14 that we can represent a mobile source as L_{F}={u_{F,0}, u_{F,1}, . . . , u_{F,T}}. The test for spatial clustering of cases about a focus at a given time t (Equation 15) may then be extended to be a focused test for clustering of exposure traces as:

$${Q}_{F , k , t}^{E} = {\sum }_{j = 1}^{N} {η}_{F , j , k , t} {c}_{j} {e}_{j , t} \qquad ( Equation 47 )$$

This is the count of the number of cases with active exposure traces that are k nearest neighbors of the focus at time t. Significance of this statistic may be evaluated by constructing exposure traces for the controls as described earlier, and by then repeatedly allocating case-control identifiers across the N lifelines that are k nearest neighbors of the focus in order to construct the reference distribution for Q_{F,k,t}^{E}. The duration weighted version of this statistic is:

$${Q}_{F , k , {ω}_{t}}^{E} = {ω}_{t} {\sum }_{j = 1}^{N} {η}_{F , j , k , t} {c}_{j} {e}_{j , t} . \qquad ( Equation 47 a )$$

Focused Test for Spatial Clustering of Exposure Traces about a Mobile Focus Through Time

We can evaluate whether there is statistically significant clustering of exposure traces of cases about a mobile focus through time using the statistic:

$${Q}_{F , k}^{E} = {\sum }_{t = 0}^{T} {Q}_{F , k , t}^{E} . \qquad ( Equation 48 )$$

This is the count, over T+1 times, of the number of cases that have active exposure traces that are k nearest neighbors of the focus at each time point. The maximum value of this statistic is kT, and its significance may be evaluated under randomization by reallocating case-control identities over the exposure traces of the cases and controls as described in the previous section. The duration-weighted version of this statistic is:

$${Q}_{F , k}^{E , ω} = {\sum }_{t = 0}^{T - 1} {Q}_{F , k , {ω}_{t}}^{E} . \qquad ( Equation 48 a )$$

Weighted Focused Tests for Exposure Traces

The power of the k-nearest neighbor based focused test for exposure traces decreases as k approaches N. Weights such as that suggested in Equation 19 may be used to construct a weighted focused test for exposure traces at a given time t:

$${Q}_{F , k , t}^{′ E} = {\sum }_{j = 1}^{N} {w}_{F , j , t} {η}_{F , j , k , t} {c}_{j} {e}_{j} . \qquad ( Equation 49 )$$

The test for focused clustering of exposure traces through time is then:

$${Q}_{F , k}^{′ E} = {\sum }_{t = 0}^{T} {Q}_{F , k , t}^{′ E} . \qquad ( Equation 50 )$$

The significance of these statistics is evaluated using randomization across the k nearest neighbors of the focus as described earlier. The corresponding duration-weighted versions are:

$${Q}_{F , k , {w}_{t}}^{′ E} = {ω}_{t} {\sum }_{j = 1}^{N} {w}_{F , j , t} {η}_{F , j , k , t} {c}_{j} {e}_{j} . \qquad ( Equation 49 a )$$

This is the weighted focused test over duration ωₜ. The duration-based weighted focused test for exposure traces through time is:

$${Q}_{F , k}^{′ E ω} = {\sum }_{t = 0}^{T} {Q}_{F , k , {ω}_{t}}^{′ E} . \qquad ( Equation 50 a )$$

Bladder Cancer in Southeastern Michigan

A population-based bladder cancer case-control study is underway in southeastern Michigan. Cases are recruited from the Michigan State Cancer Registry and diagnosed in the years 2000-2003. Controls are frequency matched to cases by age (±5 years), race, and gender, and recruited using a random digit dialing procedure from an age-weighted list. To be eligible for inclusion in the study, participants must have lived in the eleven county study area for at least the past 5 years and had no prior history of cancer (with the exception of non-melanoma skin cancer).

The data presented here are from 63 cases and 182 controls. As part of the study, participants completed a written questionnaire describing their residential mobility history. The duration of residence and exact street address were obtained, otherwise the closest cross streets were provided. Each residence in the study area was geocoded and assigned a geographic coordinate in ArcGIS; residences outside the study area were not geocoded. Participants resided at 1004 homes within the study area, with time spent averaging 64% of their lifetimes. Residences within the study area were successfully geocoded: 76% automatically matched using ArcGIS settings of spelling sensitivity equal to 75, minimum candidate score equal to 10, and a minimum match score equal to 60. The unmatched addresses were manually matched using cross streets with the assistance of internet mapping services (15%). If cross streets were not provided, best informed guess placed the address on the road (5%), and as a last resort, residence was matched to town centroid (4%). At the time of this writing geocoding and data collection are ongoing, hence the results reported in this utility patent are entirely preliminary and should not be used to draw any conclusions regarding the spatial patterns of bladder cancer in Michigan. The analysis undertaken in the manuscript is provided only as an example application of the new Q statistics.

Industrial histories have also been collected for the study area, and will be explored to explain local clustering. Industries reported to or believed to emit contaminants that have been associated with bladder cancer were identified using the Toxics Release Inventory (USEPA 2000) and the Directory of Michigan Manufacturers (Manufacturer Publishing Co., 1946, 1953, 1960, 1969, 1977, 1982). Standard Industrial Classification (SIC) codes were adopted, but prior to SIC coding, industrial classification titles were selected. Characteristics of 245 industries, including, but not limited to, fabric finishing, wood preserving, pulp mills, industrial organic chemical manufacturing, and paint, rubber, and leather manufacturing, were compiled into a database. Industries were geocoded following the same matching procedure as described for residences: 89% matched to the address, 5% were placed on the road using best informed guess, and as a last resort, 6% were matched to town centroid. Each industry was assigned a start year and end year, based on best available data. The data on these industries is used to demonstrate the focused versions of the Q statistics.

Results

To demonstrate the methods we implemented the local and global Q statistics for clustering of residential histories, specifically the local test at time t, Q_{i,k,t} (Equations 6), and its global counterpart Q_{k,t} (Equation 10). We also implemented the local test for clustering of residential histories through time Q_{i,k} (Equation 13), and the global test for clustering of residential histories Q_{i,k} (Equation 11). We also were concerned with possible clustering of cases near the industrial facilities, and evaluated this using the focused test at time t Q_{F,k,t} (Equation 15) as well as the focused test through time Q_{F,k} (Equation 16). In addition we programmed the duration-weighted versions of these statistics, and for the focused tests we also employed exposure weights calculated using the inverse rank distance (Equation 19).

Results for Qₖₜ

These techniques were implemented in TerraSeer's STIS software using the Application Programmer's Interface. This allowed us to create a methods dynamic linked library with our new techniques that we then invoked using an automatically generated dialog. Time animated maps of the places of residence of the cases and controls, and of the changing geography of the municipal water supplies, were constructed using STIS. These display the changing geography of the cases and controls as they move from one place to another, alterations in the geography of the municipal water supplies as they are founded, expand and merge, as well as township boundaries. To verify the methods we compared results using the Q statistics to those obtained using Cuzick and Edward's test in the ClusterSeer software. Specifically, we used STIS to calculate the Qₖₜ statistics through time and then exported the data for Jul. 1, 1969. We choose this time point because Qₖₜ reached a local peak of Qₖₜ=77 that was statistically significant (see FIG. 4).

FIG. 4 is a graph of Qₜₖ (top) and its Probability (bottom) though time for k=5. Qₜₖᵢ is the count of the number of k^{th} nearest neighbors of case i that also are cases, and Qₜₖ is the sum of over all cases of the Qₜₖᵢ. Shown in red are those time intervals in which the probability of Qₜₖ was 0.01 or smaller. The significance of Qₜ is obtained under conditional randomization by generating a shuffled list of case control identifiers, and then for each individual replacing the case control identifier from the shuffled list with the observed value when its contribution to the global Qₜ is considered.

The Cuzick and Edward's test in ClusterSeer returned T₅=77, confirming the results from STIS. As noted earlier, Cuzick and Edward's test is a special case of the Q-statistic for the global test at time t, Qₖₜ. Note that Qₖₜ is calculated as the sum of the local Q statistics at time t, Qᵢₖₜ, and thereby provides verification that the statistic Qᵢₖₜ, from which the family of Q statistics is derived, is being calculated correctly. The graph of Qₖₜ through time (FIG. 4) is ascending, reflecting the larger number of cases in the latter time periods. We found five periods when cases were significantly clustered relative to the controls: Jan. 1, 1929 through Jan. 1, 1935, Jan. 1, 1941 through Nov. 26, 1942, Jan. 1, 1960 through Jan. 1, 1961, Aug. 22, 1967 through Jan. 1, 1975 and Jan. 1, 1995 through Jan. 1, 1997. That these results are highly preliminary and that data collection is incomplete. In fact, discussion, it is likely the observed clustering in these data is due to the geographic ordering in which the data are being collected. Nonetheless, this example demonstrates how plots of the Qₖₜ statistics may be used to evaluate case clustering through time.

Results for Q_{k,w}_{ₜ}

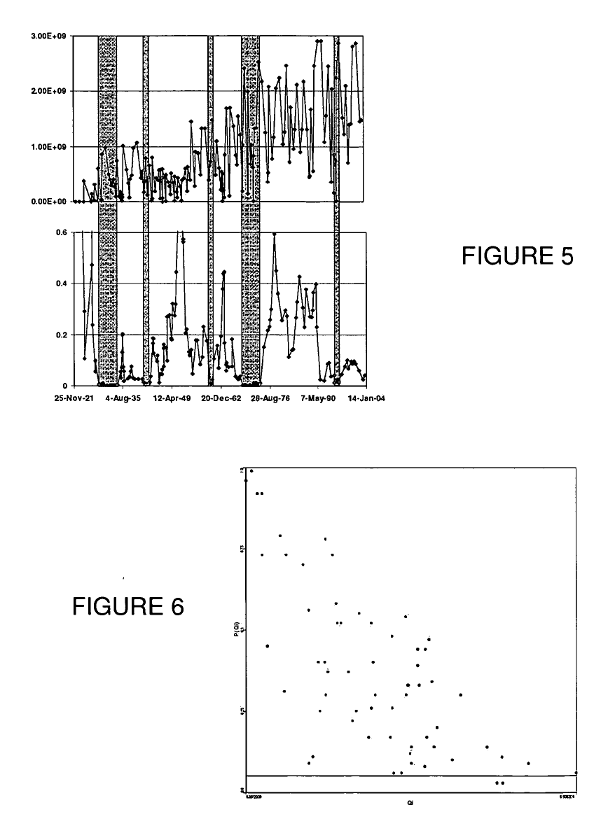

The results reported above were not time standardized. We therefore undertook an analysis using the time-standardized version of Qₖₜ called Q_{k,w}_{ₜ} as per Equation 26. This expresses the amount of clustering at a given time interval in cases per unit time period. STIS reports times down to the second, hence results are recorded in person seconds. FIG. 5 is a graph of Q_{k,w}_{ₜ} (top) and its Probability (bottom) through time for k=5. Q_{k,w}_{ₜ} is the time weighted version of the Qₜₖᵢ and is expressed in case-seconds. FIG. 5 also shows an overall increasing trend but also a greater variability in the value of the Q statistic through time. This is driven both by the increased number of cases through time and also by differences in the durations between movement events. When these sources of variability are accounted for we find episodic case clustering in approximately the same time intervals as found for the not time weighted statistic.

Results for Q_{i,k} to Evaluate Clustering of Residential Histories

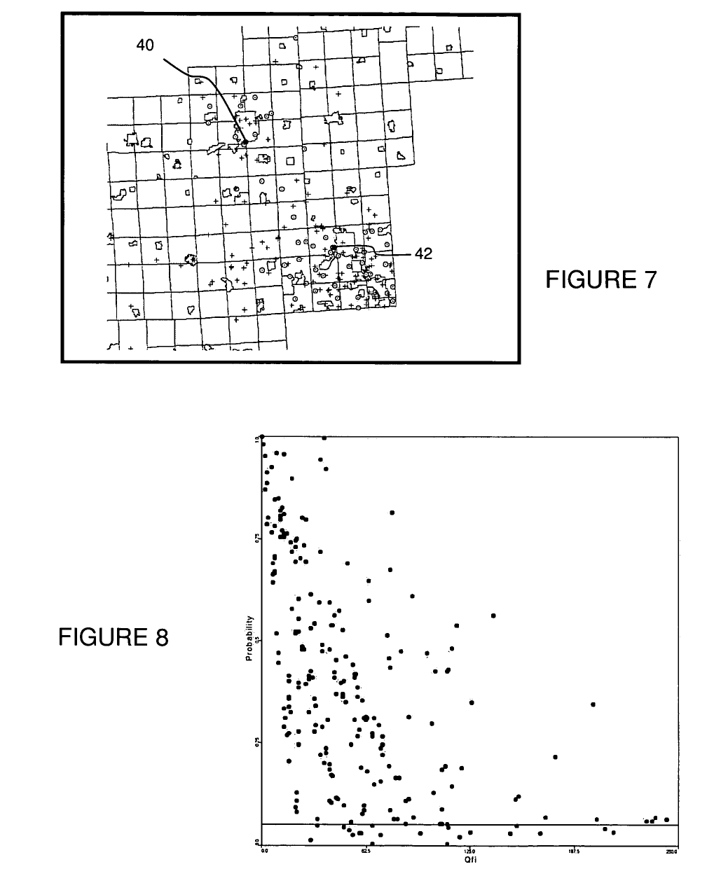

The statistics Qₖₜ and Q_{k,w}_{ₜ} are sensitive to a clustering of cases relative to the controls, and are evaluated at each of the T+1 time points in the set of residential histories. We also can ask, whether residential histories of the cases cluster near the residential histories of other cases by using the statistics Q_{i,k} (Equation 13) and its duration-weighted version Q_{i,k}^{ω} (Equation 28). Since our analysis above demonstrated the results are not overly sensitive to duration weighting, we report results only for the not-weighted tests. This test will associate a statistic and a p-value with each residential history. The distribution of the statistic and p-value are shown in FIG. 6. A map of the residential histories on Apr. 12, 1997 is shown in FIG. 7. Each point in the scatterplot represents the residential history of a case. The two residential histories with p-values less than 0.05 tend to be near the residential histories of other cases to a statistically significant extent. FIG. 7 is a map of cases and controls on 4/12/1997. Cases are shown as dots within a circle, controls are shown as crosses. Note the two dots 40, 42 that denote the place of residence of the two cases with statistically significant clustering of residential histories. Over the entire time span of the study, these two cases tend to be surrounded by residential histories of other cases, rather than the residential histories of controls. Because of residential mobility, the two red dots move about through time.

Results for Focused Clustering

To demonstrate the use of the focused versions of the Q statistic we analyzed possible clustering of the residential histories of cases near the 268 industrial facilities that produced compounds thought to be putative carcinogens for bladder cancer. We undertook two sets of analyses using Q_{F,k} (Equation 16). The first evaluated focused clustering of residential histories using the full set of k=5 nearest neighbors. The second only considered those nearest neighbors within 1 kilometer of the focus.

When considering the 5 nearest neighbors to each industry, 24 of the 268 industrial facilities had p-values less than 0.05 (FIG. 8). FIG. 8 is a plot of the probability of Q_{Fi} as a function of Qᵢ. Places of industries were not fixed over time, as several businesses changed addresses and other were founded, went out of business, or moved out of state during the study period. Of the 268 industries, 24 were the centers of focused clusters at the p<0.05 level, and of these, 2 were significant at p<0.01. None of these were significant once multiple testing was accounted for. Each point in the scatterplot represents the residential history of an industry. Thus under the null hypothesis that each person in the study had an equal probability of being labeled a case, these 24 candidate foci had a significant excess of cases among each of their five nearest neighbors, at least at the nominal 0.05 level. Notice that at the 0.05 level, we would have expected 13.4 foci to be significant under this null hypothesis. Using an experiment-wise error approach, and a 5% critical value, the adjusted alpha level of the test is 0.000187 using the Bonferonni correction, and is 0.000191 using Sidak's multiplicative inequality. Using 49,999 randomizations, we were able to resolve p-values as small as 0.00005. None of these industries proved to be statistically significant foci once multiple testing was accounted for.

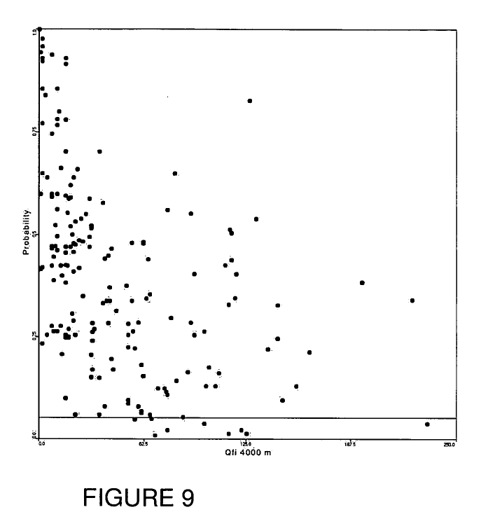

We also used the distance-based approach considering those neighbors within 4,000 m of each industrial facility. Under this approach, 10 industrial facilities had p-values <0.05 (FIG. 9), but none of these were significant once multiple testing was accounted for. FIG. 9 is a plot of the probability of Q_{Fi} as a function of Qᵢ when only those cases and controls within 4,000 m of the foci are considered. Of the 268 industries, 10 were the centers of focused clusters at the p<0.05 level. None of these were significant once multiple testing was accounted for.

Obviously, many modifications and variations of the present invention are possible in light of the above teachings. The invention may be practiced otherwise than as specifically described within the scope of the appended claims.

What is claimed is:

1. A method of evaluating clustering in case control data for a plurality of individuals taking into account dynamic location information, comprising:
establishing a set of space time coordinates for each individual, the set of space time coordinates being indicative of a geographic location of a residence of the individual at a beginning time and an ending time;
establishing a case control identifier for each individual, the case control identifier having a first control value if the individual is a case and a second control value if the individual is not a case;
establishing a neighbor relationship value between each individual and the other individuals, wherein the neighbor relationship value between one individual and another individual has a first relationship value, if the one individual and the another individual are neighbors according a set of predetermined criteria and a second relationship value are not neighbors; and,
for at least one case individual whose case control identifier has the first value, establishing a spatially and temporally local case-control cluster statistic as a function of the set of space time coordinates of each individual, the case control identifier, and the neighbor relationship values between the one case individual and the other individuals.

2. A method, as set forth in claim 1, including the step of establishing a probability of another individual being a case.

3. A method, as set forth in claim 2, including the step of establishing a global statistic for spatial clustering of cases at a time, t.

4. A method, as set forth in claim 3, of establishing a sum of the global statistic for spatial clustering over times, T+1.

5. A method, as set forth in claim 4, of establishing a test statistic as a function of the global statistic for spatial clustering, the test statistic being indicative of whether cases tend to cluster through time around a specific case.

6. A method, as set forth in claim 1, including the step of identifying a focus individual, where cases may be clustering about the focus individual.

7. A method, as set forth in claim 6, including the step of establishing a lifeline for the focus individual, the lifeline including the set of space time coordinates for the focus individual.

8. A method, as set forth in claim 7, including the step of establishing a first test statistic representing a count of neighbors of the focus individual who are cases at a focus time.

9. A method, as set forth in claim 8, including the step of establishing a second test statistic as a function of the first test statistic, the second test statistic representing count of neighbors of the focus individual who are cases between the beginning time and the ending time.

10. A method, as set forth in claim 1, wherein the set of space time coordinates for each individual take into account exposure windows and latency periods of a subject disease.

11. A method of evaluating clustering in case control data for a plurality of individuals taking into account dynamic location information, comprising:
establishing a set of space time coordinates for each individual, the set of space time coordinates being indicative of a geographic location of a residence of the individual at a beginning time and an ending time;
establishing a case control identifier for each individual, the case control identifier having a first control value if the individual is a case and a second control value if the individual is not a case;
establishing a neighbor relationship value between each individual and the other individuals, wherein the neighbor relationship value between one individual and another individual has a first relationship value, if the one individual and the another individual are neighbors according a set of predetermined criteria and a second relationship value are not neighbors;
for at least one case individual whose case control identifier has the first value, establishing a spatially and temporally local case-control cluster statistic as a function of the set of space time coordinates of each individual, the case control identifier, and the neighbor relationship values between the one case individual and the other individuals;
establishing a probability of another individual being a case;
establishing a global statistic for spatial clustering of cases at a time, t, as a function of the case control identifiers and a neutral model of spatially heterogeneous population density;
establishing a sum of the global statistic for spatial clustering over times, T+1;
establishing first test statistic as a function of the global statistic for spatial clustering, the first test statistic being indicative of whether cases tend to cluster through time around a specific case;
identifying a focus individual, where cases may be clustering about the focus individual;
establishing a lifeline for the focus individual, the lifeline including the set of space time coordinates for the focus individual;
establishing a second test statistic representing a count of neighbors of the focus individual who are cases at a focus time; and,
establishing a third test statistic as a function of the second test statistic, the third test statistic representing count of neighbors of the focus individual who are cases between the beginning time and the ending time.

12. A method, as set forth in claim 11, wherein at least one of global statistic, the first test statistic, the second test statistic, and the third test statistic are duration weighted.

13. A method, as set forth in claim 11, wherein the set of space time coordinates for each individual take into account exposure windows and latency periods of a subject disease.

14. A system for evaluating clustering in case control data for a plurality of individuals taking into account dynamic location information, comprising:
a database for storing the case control data; and,
a computer coupled to the database for establishing a set of space time coordinates for each individual as a function of the case control data, the set of space time coordinates being indicative of a geographic location of a residence of the individual at a beginning time and an ending time, for establishing a case control identifier for each individual, the case control identifier having a first control value if the individual is a case and a second control value if the individual is not a case, for establishing a neighbor relationship value between each individual and the other individuals, wherein the neighbor relationship value between one individual and another individual has a first relationship value, if the one individual and the another individual are neighbors according a set of predetermined criteria and a second relationship value are not neighbors, and, for at least one case individual whose case control identifier has the first value, for establishing a spatially and temporally local case-control cluster statistic as a function of the set of space time coordinates of each individual, the case control identifier, and the neighbor relationship values between the one case individual and the other individuals.

15. A system, as set forth in claim 14, the computer for establishing a probability of another individual being a case.

16. A system, as set forth in claim 15, the computer for establishing a global statistic for spatial clustering of cases at a time, t.

17. A system, as set forth in claim 16, the computer for establishing a sum of the global statistic for spatial clustering over times, T+1.

18. A system, as set forth in claim 17, the computer for establishing a test statistic as a function of the global statistic for spatial clustering, the test statistic being indicative of whether cases tend to cluster through time around a specific case.

19. A system, as set forth in claim 14, the computer for identifying a focus individual, where cases may be clustering about the focus individual.

20. A system, as set forth in claim 19, the computer for establishing a lifeline for the focus individual, the lifeline including the set of space time coordinates for the focus individual.

21. A system, as set forth in claim 20, the computer for establishing a first test statistic representing a count of neighbors of the focus individual who are cases at a focus time.

22. A system, as set forth in claim 21, the computer for establishing a second test statistic as a function of the first test statistic, the second test statistic representing count of neighbors of the focus individual who are cases between the beginning time and the ending time.

23. A system, as set forth in claim 14, wherein the set of space time coordinates for each individual take into account exposure windows and latency periods of a subject disease.

24. A system for evaluating clustering in case control data for a plurality of individuals taking into account dynamic location information, comprising:
a database for storing case control data;
a computer coupled to the database for establishing a set of space time coordinates for each individual as a function of the case control data, the set of space time coordinates being indicative of a geographic location of a residence of the individual at a beginning time and an ending time, for establishing a case control identifier for each individual, the case control identifier having a first control value if the individual is a case and a second control value if the individual is not a case, for establishing a neighbor relationship value between each individual and the other individuals, wherein the neighbor relationship value between one individual and another individual has a first relationship value, if the one individual and the another individual are neighbors according a set of predetermined criteria and a second relationship value are not neighbors, for at least one case individual whose case control identifier has the first value, for establishing a spatially and temporally local case-control cluster statistic as a function of the set of space time coordinates of each individual, the case control identifier, and the neighbor relationship values between the one case individual and the other individuals, for establishing a probability of another individual being a case, for establishing a global statistic for spatial clustering of cases at a time, t, as a function of the case control identifiers and a neutral model of spatially heterogeneous population density, for establishing a sum of the global statistic for spatial clustering over times, T+1, for establishing first test statistic as a function of the global statistic for spatial clustering, the first test statistic being indicative of whether cases tend to cluster through time around a specific case, for identifying a focus individual, where cases may be clustering about the focus individual, for establishing a lifeline for the focus individual, the lifeline including the set of space time coordinates for the focus individual, for establishing a second test statistic representing a count of neighbors of the focus individual who are cases at a focus time, and for establishing a third test statistic as a function of the second test statistic, the third test statistic representing count of neighbors of the focus individual who are cases between the beginning time and the ending time.

25. A system, as set forth in claim 24, wherein at least one of global statistic, the first test statistic, the second test statistic, and the third test statistic are duration weighted.

26. A system, as set forth in claim 24, wherein the set of space time coordinates for each individual take into account exposure windows and latency periods of a subject disease.

27. A system, as set forth in claim 24, wherein the database includes information on the locations and times of operation of putative exposure sources and wherein the location history data is used to identify the putative relative importance of those exposure sources in terms of exposures that might have been causative in causing the cancer of a particular case.
